(19) United States
(12) Patent Application Publication
(10) Pub. No.: US 2026/0115970 A1
(43) Pub. Date: Apr. 30, 2026

(54) RESIN RECOVERY METHOD AND RESIN RECOVERY SYSTEM

(71) Applicant: HONDA MOTOR CO., LTD., Tokyo (JP)

(72) Inventors: Daisuke OKAMURA, Saitama (JP); Ryosuke KODAIRA, Saitama (JP); Yoichiro SUZUKI, Saitama (JP)

(21) Appl. No.: 19/372,565

(22) Filed: Oct. 29, 2025

(30) Foreign Application Priority Data
Oct. 30, 2024 (CN) 202411529413.9

(51) Int. Cl. B29B 13/10; B29B 17/02; B29B 17/04

(52) U.S. Cl. CPC B29B 13/10; B29B 2017/0224; B29B 2017/0227; B29B 2017/0468

(57) ABSTRACT

A resin recovery method comprises a crushing step, a sieving step, and a collecting step. In the crushing step, a resin-product-equipped harness is loaded into the crusher having a striking portion that rotates about a predetermined axis to crush the resin product with the striking portion into resin pieces. In the sieving step, the harness and the resin pieces are loaded into a sieving device having an upper sieve and a lower sieve provided below the upper sieve, from above the upper sieve. In the collecting step, the resin pieces that have passed through the upper and lower sieves are collected.

This application is based on and claims the benefit of priority from Chinese Patent Application No. CN202411529413.9, filed on 30 October 2024, the content of which is incorporated herein by reference.

### BACKGROUND OF THE INVENTION

### Field of the Invention

The present invention relates to a method and a system for recovering a resin from a resin-product-equipped harness.

### Related Art

Conventionally, efforts aimed at alleviating or reducing the effects of climate change have been ongoing. In order to achieve this, research and development of techniques relating to recycling of resins or the like is being conducted.

Patent Document 1: Japanese Unexamined Patent Application, Publication No. 2004-196853

### SUMMARY OF THE INVENTION

Some of various harnesses used for electrical wiring, communication wiring, or the like are provided with a resin product such as a connector or a base member. It is laborious for workers to detach resin products one by one from these harnesses and recover the resin, which leads to an increase in recycling costs.

The present invention has been made in light of the above-described circumstances, and an object of the present invention is to efficiently recover a resin from a resin-product-equipped harness.

The present inventors have found that a resin can be efficiently recovered by crushing a resin product attached to a harness into resin pieces and then passing the harness and the resin pieces through a predetermined sieving device, and have reached the present invention. The present invention provides the following resin recovery methods (1) to (7) and the following resin recovery system (8).

1. A resin recovery method for recovering a resin from a resin-product-equipped harness as a harness to which a resin product is attached, the method including:

a crushing step of loading the resin-product-equipped harness into a crusher having a striking portion that rotates about a predetermined axis, to crush the resin product into resin pieces by the striking portion;

a sieving step of loading the harness and the resin pieces into a sieving device having an upper sieve and a lower sieve provided below the upper sieve, from above the upper sieve, and sieving the harness and the resin pieces; and

a collecting step of collecting the resin pieces that have passed through the upper sieve and the lower sieve.

In the crushing step, the resin product is crushed into resin pieces by the striking portion. Thus, the resin product can be efficiently detached from the harness. On the other hand, the harness has flexibility, and thus, is unlikely to be crushed by the striking portion.

In the sieving step, the harness and the resin pieces are loaded into a sieving device and sieved. At this time, since the harness is elongated, the lower end portion of the harness is likely to abut against the lower sieve while passing through a sieve hole of the upper sieve. Therefore, the harness is likely to stay in this state, and is unlikely to pass through the lower sieve. On the other hand, the resin pieces pass through sieve holes of the upper sieve and then, easily pass through the lower sieve as they are.

Therefore, in the collecting step, the resin can be efficiently recovered by collecting the resin pieces that have passed through the upper sieve and the lower sieve.

2. The resin recovery method as described in 1 above,

in which, in a top view, sieve holes of the upper sieve do not overlap with any of sieve holes of the lower sieve.

According to this configuration, the lower end portion of the harness that is passing through the upper sieve is likely to abut against a portion of the lower sieve other than the sieve holes. Therefore, the harness is less likely to pass through the lower sieve.

3. The resin recovery method as described in 2 above,

in which, in a top view, the upper sieve has sieve holes in a predetermined first region and does not have sieve holes in a predetermined second region, and

in a top view, the lower sieve does not have sieve holes in the first region and has sieve holes in the second region.

According to this configuration, since the first region per se, in which the sieve holes of the upper sieve are present in a top view, does not overlap with the second region, in which the sieve holes of the lower sieve are present, harness pieces are more unlikely to pass through the sieve holes of the lower sieve.

4. The resin recovery method as described in 3,

in which, in a top view, the second region is an annular region surrounding the first region from a periphery.

According to this configuration, the resin pieces that have passed through the sieve holes in the first region of the upper sieve and have fallen on the first region of the lower sieve easily reach second region R2 present around the first region, and thus easily reach the sieve holes of the lower sieve.

5. The resin recovery method as described in 4 above,

in which the sieving device includes a vibration device that bidirectionally vibrates the upper sieve and the lower sieve about a vertical direction as an axis, and

in the sieving step, the harness and the resin pieces are sieved by vibration of the vibration device.

According to this configuration, the resin pieces that have fallen from the sieve holes in the first region of the upper sieve to the lower sieve are outwardly guided, that is, to a second region side, by the centrifugal force due to the bidirectional vibration about the vertical direction as an axis. Therefore, the resin pieces are easily guided to the sieve holes of the lower sieve.

6. The resin recovery method as described in any one of 3 to 5,

in which, in the sieving step, a cylindrical body opened in the vertical direction is installed on the first region of the upper sieve, and the harness and the resin pieces are fed into the cylindrical body, whereby the harness and the resin pieces are loaded into the sieving device.

According to this configuration, the harness and the resin pieces can be efficiently guided to the sieve holes of the upper sieve.

7. The resin recovery method as described in any one of 1 to 6, including

a cutting step of cutting the harness into a plurality of harness pieces before the crushing step,

in which, in the cutting step, the harness is cut so that a length of each of the harness pieces to which a resin product is attached is longer than a gap between the upper sieve and the lower sieve, and

in the crushing step, the harness pieces to which a resin product is attached are loaded into the crusher.

By cutting the harness into a plurality of harness pieces in the cutting step, it is possible to make the harness less likely to be entangled with the striking portion. Therefore, the output of the crusher can be suppressed. Further, in this cutting step, the harness is cut so that a length of each of the harness pieces to which a resin product is attached is longer than the gap between the upper sieve and the lower sieve. Thus, in the sieving step, the lower end portion of each of the harness pieces can be ensured to abut against the lower sieve while the harness pieces are passing through the sieve holes of the upper sieve.

8. A resin recovery system for recovering a resin from a resin-product-equipped harness as a harness to which a resin product is attached, the system including:

a crusher having a striking portion that rotates about a predetermined axis, the crusher detaching the resin product from the harness by crushing the resin product into resin pieces with the striking portion when the resin-product-equipped harness is loaded, and

a sieving device having an upper sieve and a lower sieve provided below the upper sieve, the harness staying above the lower sieve and the resin pieces passing through the upper sieve and the lower sieve when the harness and the resin pieces are loaded.

According to the system of the present configuration, the method 1can be implemented. Thus, the resin can be efficiently recovered from the resin-product-equipped harness.

As described above, according to the method (1) and the system (8), the resin can be efficiently recovered from a resin-product-equipped harness. Further, according to the methods (2) to (7) citing (1), additional effects specific to each can be obtained.

### BRIEF DESCRIPTION OF THE DRAWINGS

FIG. 1 is a configuration diagram showing a resin recovery system of the present embodiment;

FIG. 2 is a perspective view showing a crusher;

FIG. 3 is a perspective view showing a sieving device;

FIG. 4 is a perspective view showing an upper sieve and a lower sieve;

FIG. 5 is a top view showing the upper sieve and the lower sieve; and

FIG. 6 is a front cross-sectional view showing the upper sieve and the lower sieve, specifically showing a cross section taken along line fg6-fg6 in FIG. 5.

### DETAILED DESCRIPTION OF THE INVENTION

Hereinafter, embodiments of the present invention are described with reference to the drawings. However, the present invention is not limited to the following embodiments at all, and can be appropriately modified and implemented within a range not departing from the gist of the present invention.

### First Embodiment

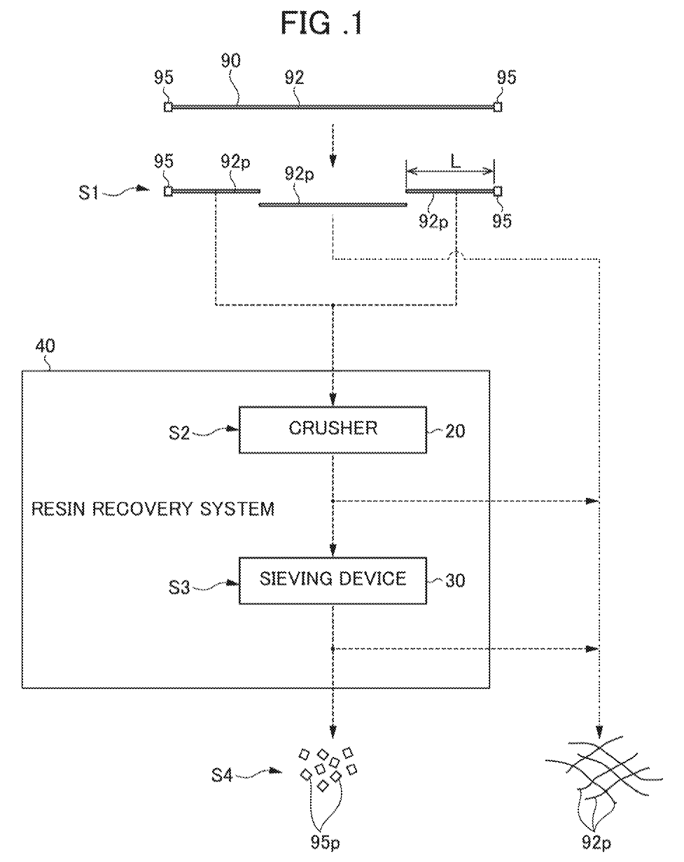

A resin recovery system 40 shown in FIG. 1 is a system for recovering a resin of a resin product 95 from a harness 90 with a resin product as a harness 92 to which a resin product 95, such as a connector, is attached. The harness 92 is, for example, a corrugated tube or a copper wire. The resin product 95 is a resin product made of a hard resin, such as a connector or a base component. More specifically, examples of the resin included in the resin product 95 include polybutylene terephthalate (PBT), polyamide (PA), polypropylene (PP), etc.

This resin recovery system 40 includes a crusher 20 and a sieving device 30.

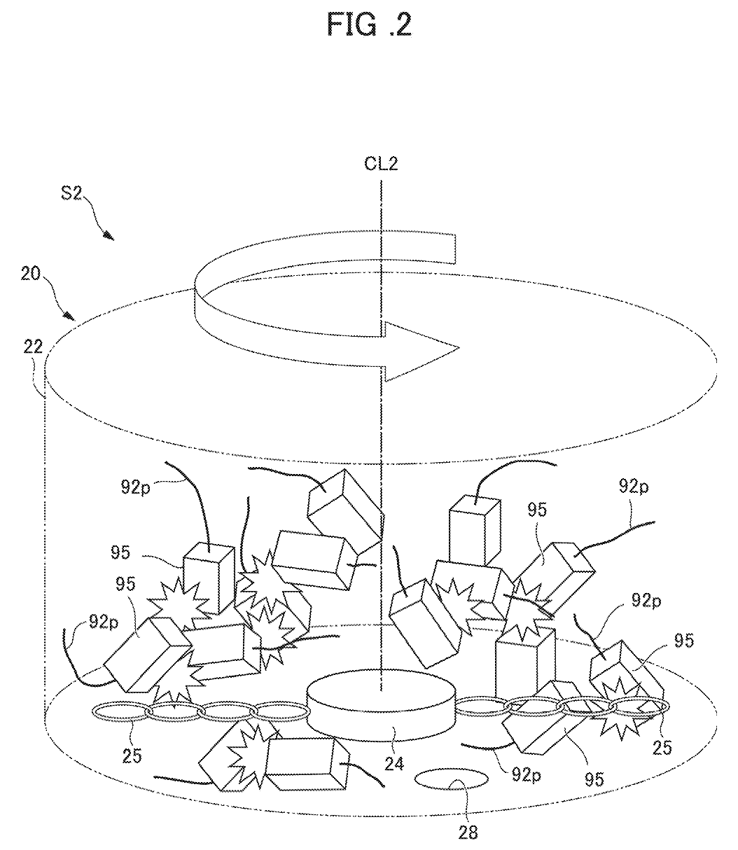

The crusher 20 shown in FIG. 2 is a cross-flow shredder or the like used when taking out contents from casings. The crusher 20 includes a storage container 22, a rotating body 24, a plurality of striking portions 25, and a discharge port 28. Hereinafter, a center line of the crusher 20 is referred to as a "center line CL2". More specifically, this center line CL2 is a center line of the storage container 22.

The storage container 22 is a cylindrical container whose vertical direction is the longitudinal direction of the center line CL2. The rotating body 24 is provided so as to be rotatable about the center line CL2 as an axis in a central portion of a bottom portion of the storage container 22. Each of the striking portions 25 is a chain or the like, and one end portion thereof is attached to the rotating body 24. Therefore, each striking portion 25 rotates about the center line CL2 as an axis together with the rotating body 24 in the storage container 22. In the present embodiment, a length of each striking portion 25 is about 400 mm.

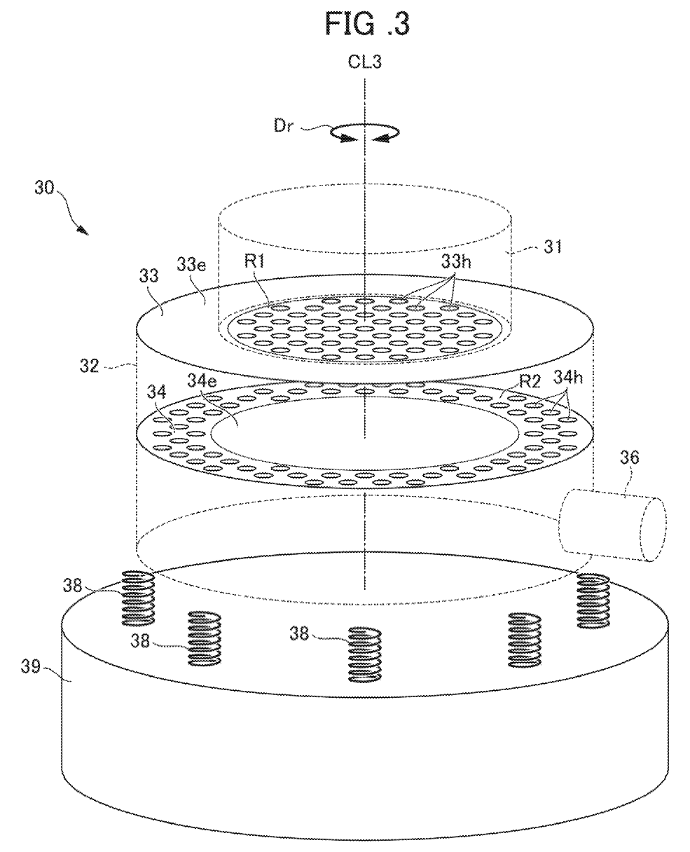

As shown in FIG. 3, the sieving device 30 includes a housing 32, an upper sieve 33, a lower sieve 34, and a vibration device 39. Hereinafter, the center line of the sieving device 30 is referred to as a "center line CL3". More specifically, the center line CL3 is a center line of the housing 32.

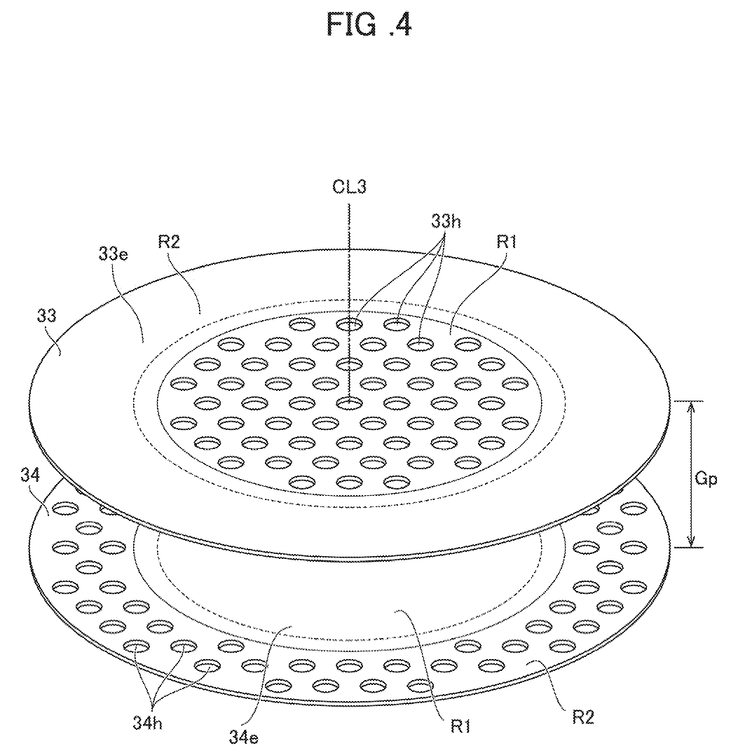

As shown in FIG. 4, both the upper sieve 33 and the lower sieve 34 have a circular shape in a top view, and the centers thereof are disposed on the center line CL3. As shown in FIG. 3, the housing 32 is a bottomed cylindrical container whose vertical direction is the longitudinal direction of the center line CL3, and opens upward. The upper sieve 33 is fixed to an upper end of the housing 32 so as to close the opening. The lower sieve 34 is fixed to an intermediate portion in the vertical direction in the housing 32. Therefore, the lower sieve 34 is provided below the upper sieve 33. In the present embodiment, gap Gp between the upper sieve 33 and the lower sieve 34 shown in FIG. 4 is about 150 mm. As shown in FIG. 3, a discharge port 36 is provided in a side portion located below the lower sieve 34 in the housing 32.

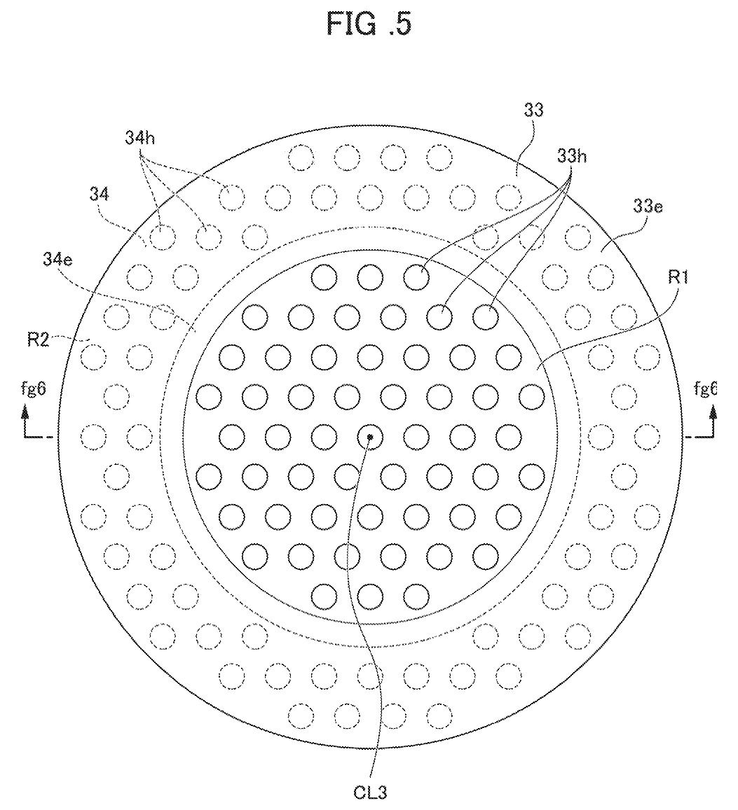

Hereinafter, as shown in FIG. 5, a predetermined circular region centered on the center line CL3 in a top view is referred to as a "first region R1". In the present embodiment, the diameter of the first region R1 is about 180 mm. Hereinafter, in a top view, a predetermined annular region surrounding the first region R1 is referred to as a "second region R2". That is, both the inner edge and the outer edge of the annular second region R2 are circular with the center line CL3 as the center. In the present embodiment, the diameter of the inner edge in the second region R2 is about 230 mm.

As shown in FIG. 4, the upper sieve 33 has sieve holes 33h in the first region R1, and does not have sieve holes 33h in the region including the second region R2. On the other hand, the lower sieve 34 has no sieve holes 34h in the region including the first region R1, and has sieve holes 34h in the second region R2. Therefore, in a top view shown in FIG. 5, none of the sieve holes 33h of the upper sieve 33 overlaps with any of the sieve holes 34h of the lower sieve 34.

More specifically, in the present embodiment, both the upper sieve 33 and the lower sieve 34 shown in FIG. 4 are configured based on the same sieve. The mesh size of the sieve is, for example, about 10 mm. The upper sieve 33 is provided with an annular sealing member 33e, in a top view, outside the first region R1, that is, in a region including the second region R2. Therefore, the upper sieve 33 including this sealing member 33e has no sieve holes 33h in a region other than the first region R1, that is, in a region including the second region R2. On the other hand, the lower sieve 34 is provided with a circular sealing member 34e, in a top view, in an inner side of the second region R2, that is, in a region including the first region R1. Therefore, the lower sieve 34 including this sealing member 34e has no sieve holes 34h in a region other than the second region R2, that is, in a region including the first region R1.

The vibration device 39 shown in FIG. 3 is configured such that the housing 32, the upper sieve 33, and the lower sieve 34 can be vibrated as an integral object in both directions of the rotation direction Dr about the central line CL3 as an axis. Note that a plurality of springs 38 for allowing the housing 32 to move relative to the vibration device 39 in the vertical direction are attached between the vibration device 39 and the housing 32.

Next, a resin recovery method of the present embodiment performed using the resin recovery system 40 described above is described. As shown in FIG. 1, the resin recovery method includes a cutting step S1, a crushing step S2, a sieving step S3, and a collecting step S4.

First, in the cutting step S1, an operator cuts each of a plurality of harnesses 92 into a plurality of harness pieces 92p. At this time, a length L of a harness piece 92p to which a resin product 95 is attached is set to about 500 mm. Therefore, the length of the harness piece 92p to which a resin product 95 is attached is longer than the gap Gp (about 150 mm) between the upper sieve 33 and the lower sieve 34 shown in FIG. 4. Note that the "harness piece 92p" may read as a "harness" because the "harness piece 92p" is the harness 92 that has been cut. Further, the "harness piece 92p to which a resin product 95 is attached" may read as a "resin-product-equipped harness".

Next, in the crushing step S2 shown in FIG. 1, the operator loads the harness piece 92p to which a resin product 95 is attached into the crusher 20. On the other hand, the harness piece 92p to which the resin product 95 is not attached is discarded without being loaded into the crusher 20.

Thereafter, in the crushing step S2, the operator starts up the crusher 20 shown in FIG. 2. As a result, the rotating body 24 rotates together with a plurality of striking portions 25. Then, the striking portions 25 crush each of the resin products 95 into a plurality of resin pieces 95p. Most of the resin pieces 95p flow into the discharge port 28 and are discharged from the discharge port 28. Thereafter, the operator stops the operation of the crusher 20, removes the harness pieces 92p from the inside of the storage container 22 within a possible range, and discards them. Then, the operator flows a mixture of the harness pieces 92p and the resin pieces 95p remaining in the storage container 22 into the discharge port 28.

Thereafter, in the sieving step S3 shown in FIG. 1, the operator loads the harness pieces 92p and the resin pieces 95p discharged from the discharge port 28 into the sieving device 30. At this time, as shown in FIG. 3, a cylindrical body 31 opened in the vertical direction is installed on the first region R1 of the upper sieve 33. By feeding the harness pieces 92p and the resin pieces 95p into the cylindrical body 31, the mixture of the harness pieces 92p and the resin pieces 95p is loaded into the sieving device 30.

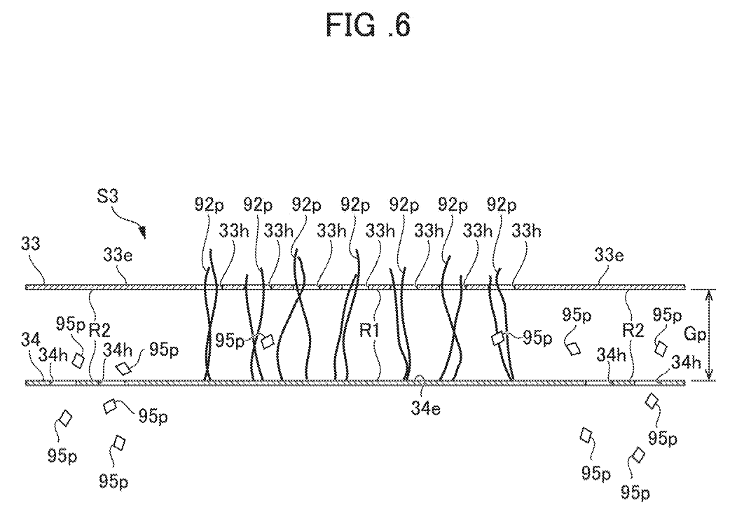

Thereafter, in this sieving step S3, the operator starts up the vibration device 39 to perform the sieving operation. At this time, as shown in FIG. 6, most of the resin pieces 95p sequentially pass through the sieve holes 33h of the upper sieve 33 and the sieve holes 34h of the lower sieve 34, and fall downward. Therefore, most of the resin pieces 95p flow into the discharge port 36 shown in FIG. 3 and are discharged from the discharge port 36. On the other hand, as shown in FIG. 6, for most of the harness pieces 92p, their lower end portions abut against the sealing member 34e of the lower sieve 34 while passing through the sieve holes 33h of the upper sieve 33. That is, the lower end portion of each harness piece 92p abuts against a portion of the lower sieve 34 where the sieve holes 34h are not provided. Thus, most of the harness pieces 92p remain above the lower sieve 34.

Thereafter, in the collecting step S4 shown in FIG. 1, the operator collects the resin pieces 95p discharged from the discharge port 36 of the sieving device 30. On the other hand, the harness pieces 92p remaining between the upper sieve 33 and the lower sieve 34 are discarded.

The configuration and effects of the present embodiment are summarized below.

As shown in FIG. 2, in the crushing step S2, the resin products 95 are crushed into resin pieces 95p by using the striking portions 25. Thus, the resin products 95 can be efficiently detached from the harness pieces 92p. On the other hand, the harness pieces 92p have flexibility, and thus are unlikely to be crushed by the striking portions 25.

In the subsequent sieving step S3 shown in FIG. 6, the harness pieces 92p and the resin pieces 95p are loaded into the sieving device 30 and sieved. At this time, since each harness piece 92p is elongated, the lower end portion of the harness piece 92p easily abuts against the lower sieve 34 while passing through each sieve hole 33h of the upper sieve 33. Therefore, the harness pieces 92p are likely to remain in this state, and are difficult to pass through the lower sieve 34. On the other hand, after passing through the sieve holes 33h of the upper sieve 33, the resin pieces 95p easily pass through the sieve holes 34h of the lower sieve 34 as they are.

Therefore, in the subsequent collecting step S4, the resin can be efficiently recovered by collecting the resin pieces 95p that have passed through the upper sieve 33 and the lower sieve 34.

In the top view shown in FIG. 5, the sieve holes 33h of the upper sieve 33 do not overlap with any of the sieve holes 34h of the lower sieve 34. Thus, as shown in FIG. 6, the harnesses 92 that have passed through the upper sieve 33 are likely to abut against a portion other than the sieve holes 34h of the lower sieve 34. Therefore, the harnesses 92 are less likely to pass through the lower sieve 34.

Specifically, in the top view shown in FIG. 5, the upper sieve 33 has the sieve holes 33h in the first region R1, and does not have the sieve holes 33h in the second region R2. On the other hand, the lower sieve 34 has no sieve holes 34h in the first region R1, and has sieve holes 34h in the second region R2. As described above, in the top view, the first region R1 itself where the sieve holes 33h of the upper sieve 33 are present does not overlap with the second region R2 where the sieve holes 34h of the lower sieve 34 are present, and thereby it becomes more difficult for the harness pieces 92p to pass through the sieve holes 34h of the lower sieve 34.

More specifically, in the top view illustrated in FIG. 5, the second region R2 is an annular region surrounding the first region R1 from the periphery. Therefore, the resin pieces 95p that have passed through the sieve holes 33h in the first region R1 of the upper sieve 33 illustrated in FIG. 4 and have fallen onto the first region R1 of the lower sieve 34 easily reach the second region R2 present around the first region R1, and thus easily reach the sieve holes 34h of the lower sieve 34.

As shown in FIG. 3, the sieving device 30 includes the vibration device 39 that vibrates the upper sieve 33 and the lower sieve 34 in both directions of the rotation direction Dr about the vertical direction as an axis. In the sieving step S3, the harness pieces 92p and the resin pieces 95p are sieved by the vibration of the vibration device 39. Thereby, the resin pieces 95p that have fallen from the sieve holes 33h present in the first region R1 of the upper sieve 33 illustrated in FIG. 4 onto the lower sieve 34 are outwardly guided, that is, to the second region R2side, by the centrifugal force due to the vibration in both directions of the rotation direction Dr about the vertical direction as an axis. Therefore, the resin pieces 95p are easily guided to the sieve holes 34h of the lower sieve 34.

In the sieving step S3, the cylindrical body 31 opened in the vertical direction is installed on the first region R1 of the upper sieve 33 shown in FIG. 3. A mixture of the harness pieces 92p and the resin pieces 95p is fed into the cylindrical body 31. Therefore, the mixture of the harness pieces 92p and the resin pieces 95p can be efficiently guided to the sieve holes 33h of the upper sieve 33.

In the cutting step S1 shown in FIG. 1, by cutting the harness 92 into a plurality of harness pieces 92p, it is possible to make the harness 92 less likely to be entangled with the striking portions 25 shown in FIG. 2. Therefore, the output of the crusher 20 can be suppressed. In order to obtain this effect more reliably, the length L of the harness piece 92p is preferably 2.0 times or less, and more preferably 1.5 times or less the length of the striking portion 25.

Further, in the cutting step S1 shown in FIG. 1, the harness 92 is cut so that the length L of the harness piece 92p to which a resin product 95 is attached is longer than the gap Gp between the upper sieve 33 and the lower sieve 34 shown in FIG. 6. Therefore, in the sieve step S3 shown in FIG. 6, it is possible to ensure that the lower end portion of each harness piece 92p abuts against the lower sieve 34 while the harness piece 92p is being inserted through the sieve hole 33h of the upper sieve 33. In order to obtain this effect more reliably, the length L of the harness piece 92p is preferably 1.5 times or more the gap Gp, more preferably 2.0 times or more.

### Other Embodiments

The embodiment described above can be modified as follows, for example. In a case where there is no risk that the harnesses 92 will become entangled with the striking portions 25 even if the cutting step S1 shown in FIG. 1 is eliminated, or the like, the cutting step S1 may be eliminated, and harnesses 90 with a resin product may be loaded into the crusher 20 as they are.

Unlike the case shown in FIG. 5, in the top view, for example, the sieve holes 33h of the upper sieve 33 and the sieve holes 34h of the lower sieve 34 may be alternately disposed so that the sieve holes 33h of the upper sieve 33 do not overlap with any of the sieve holes 34h of the lower sieve 34. However, preferably, as shown in FIG. 5, the first region R1 itself, where the sieve holes 33h of the upper sieve 33 are present, does not overlap with the second region R2, where the sieve holes 34h of the lower sieve 34 are present.

### EXPLANATION OF REFERENCE NUMERALS

20 CRUSHER

25 STRIKING PORTION

30 SIEVING DEVICE

31 CYLINDRICAL BODY

33 UPPER SIEVE

33h SIEVE HOLE OF UPPER SIEVE

34 LOWER SIEVE

34h SIEVE HOLE OF LOWER SIEVE

39 VIBRATION DEVICE

40 RESIN RECOVERY SYSTEM

90 RESIN-PRODUCT-EQUIPPED HARNESS

92 HARNESS

92P HARNESS PIECE

95 RESIN PRODUCT

95P RESIN PIECES

G_{P} GAP BETWEEN UPPER SIEVE AND LOWER SIEVE

L LENGTH OF HARNESS PIECE WITH RESIN PRODUCT

R1 FIRST REGION

R2 SECOND REGION

S1 CUTTING STEP

S2 CRUSHING STEP

S3 SIEVING STEP

S4 COLLECTING STEP

What is claimed is:

1. A resin recovery method for recovering a resin from a resin-product-equipped harness as a harness to which a resin product is attached, the method comprising:
a crushing step of loading the resin-product-equipped harness into a crusher having a striking portion that rotates about a predetermined axis, to crush the resin product into resin pieces by the striking portion;
a sieving step of loading the harness and the resin pieces into a sieving device having an upper sieve and a lower sieve provided below the upper sieve, from above the upper sieve, and sieving the harness and the resin pieces; and
a collecting step of collecting the resin pieces that have passed through the upper sieve and the lower sieve.

2. The resin recovery method according to claim 1,
wherein, in a top view, sieve holes of the upper sieve do not overlap with any of sieve holes of the lower sieve.

3. The resin recovery method according to claim 2,
wherein, in a top view, the upper sieve has sieve holes in a predetermined first region and does not have sieve holes in a predetermined second region, and
in a top view, the lower sieve does not have sieve holes in the first region and has sieve holes in the second region.

4. The resin recovery method according to claim 3,
wherein, in a top view, the second region is an annular region surrounding the first region from a periphery.

5. The resin recovery method according to claim 4,
wherein the sieving device comprises a vibration device that bidirectionally vibrates the upper sieve and the lower sieve about a vertical direction as an axis, and
in the sieving step, the harness and the resin pieces are sieved by vibration of the vibration device.

6. The resin recovery method according to claim 3,
wherein, in the sieving step, a cylindrical body opened in a vertical direction is installed on the first region of the upper sieve, and the harness and the resin pieces are fed into the cylindrical body, whereby the harness and the resin pieces are loaded into the sieving device.

7. The resin recovery method according to claim 1 comprising
a cutting step of cutting the harness into a plurality of harness pieces before the crushing step,
wherein, in the cutting step, the harness is cut so that a length of each of the harness pieces to which a resin product is attached is longer than a gap between the upper sieve and the lower sieve, and
in the crushing step, the harness pieces to which a resin product is attached are loaded into the crusher.

8. A resin recovery system for recovering a resin from a resin-product-equipped harness as a harness to which a resin product is attached, the system comprising:
a crusher having a striking portion that rotates about a predetermined axis, the crusher detaching the resin product from the harness by crushing the resin product into resin pieces with the striking portion when the resin-product-equipped harness is loaded, and
a sieving device having an upper sieve and a lower sieve provided below the upper sieve, the harness staying above the lower sieve and the resin pieces passing through the upper sieve and the lower sieve when the harness and the resin pieces are loaded.
